(19) United States
(12) Patent Application Publication
(10) Pub. No.: US 2023/0413367 A1
(43) Pub. Date: Dec. 21, 2023

(54) METHODS FOR UPLINK MULTI-USER TRANSMISSION IN WIRELESS LOCAL AREA NETWORK AND ACCESS POINT

(71) Applicant: GUANGDONG OPPO MOBILE TELECOMMUNICATIONS CORP., LTD., Dongguan (CN)

(72) Inventor: Lei HUANG, Singapore (SG)

(21) Appl. No.: 18/459,015

(22) Filed: Aug. 30, 2023

Related U.S. Application Data
(63) Continuation of application No. PCT/CN2022/070823, filed on Jan. 7, 2022.

(30) Foreign Application Priority Data
Mar. 5, 2021 (SG) 10202102250X

(51) Int. Cl. H04W 76/20

(52) U.S. Cl. CPC H04W 76/20; H04W 84/12

(57) ABSTRACT

Methods for uplink (UL) multi-user (MU) transmission in a wireless local area network (WLAN) and an access point (AP) are provided. The method comprises: setting, by an AP, a Common Info field or a plurality of User Info fields of a trigger frame to indicate whether a resource unit (RU) adaptation is enabled for a plurality of STAs indicated by the plurality of User Info fields, and transmitting, by the AP, a physical layer protocol data unit (PPDU) including the trigger frame to the plurality of STAs.

### CROSS REFERENCE TO RELATED APPLICATION(S)

This application is a continuation of International Application No. PCT/CN2022/070823, filed Jan. 7, 2022, which claims priority to Singapore Patent Application No. 10202102250X, filed Mar. 5, 2021, the entire disclosures of which are incorporated herein by reference.

### FIELD OF INVENTION

The invention relates to uplink transmission in wireless communications, and more particularly to methods for resource adaptive uplink (UL) multi-user (MU) transmission in a wireless local area network (WLAN) and an access point (AP).

### BACKGROUND

Institute of Electrical and Electronics Engineers (IEEE) 802.11 TGbe is developing a new IEEE 802.11 amendment which defines extremely high throughput (EHT) physical layer (PHY) and medium access control (MAC) layers capable of supporting a maximum throughput of at least 30 Gbps. To this end, it has been proposed to increase maximum channel bandwidth to 320 MHz and allow a multiple resource unit (MRU) to be allocated to a single STA in a trigger-based UL MU transmission.

FIG. 1 is a schematic view illustrating a trigger-based (TB) UL MU transmission according to the prior art. As shown in FIG. 1, an access point (AP) may transmit a trigger frame to solicit simultaneous 160 MHz EHT TB physical layer protocol data unit (PPDU) transmissions from two stations STA1 and STA2. The trigger frame indicates one 484+996 tone MRU is allocated to STA1 and one 484 tone resource unit (RU) is allocated to STA2. The trigger frame also indicates STA1 and STA2 shall use energy detection (ED) to sense medium and to consider a medium state and a network allocation vector (NAV) in determining whether or not to respond. In this case, each of STA1 and STA2 shall perform the ED at least in the subchannel that includes its UL allocation during the short interframe spacing (SIFS) after receiving the PPDU that includes the trigger frame, where the sensed subchannels for STA1 and STA2 consist of six 20 MHz channels and two 20 MHz channels, respectively. The PPDU including the trigger frame may be a high throughput (HT) PPDU, a non-HT PPDU, a very high throughput (VHT) PPDU, a high efficiency (HE) PPDU, or an EHT PPDU. STA2 detects that the two 20 MHz channels including the allocated 484 tone RU are all idle, and thus STA2 transmits an EHT TB PPDU to the AP. However, STA1 detects that not all of the six 20 MHz channels including the allocated 484+996 tone MRU are idle, and thus STA1 shall not transmit an EHT TB PPDU to the AP. As a result, the whole allocated 484+996 tone MRU for STA1 is wasted even if only one of the six 20 MHz channels including the allocated 484+996 tone MRU for STA1 is considered busy, which would significantly degrade system throughput.

It would therefore be desirable to provide a more efficient mechanism/solution for UL MU transmission in a WLAN, especially in IEEE 802.11 TGbe WLAN.

### SUMMARY OF INVENTION

In a first aspect, a method for uplink (UL) multi-user (MU) transmission in a wireless local area network (WLAN) is provided. The method comprises: setting, by an AP, a Common Info field or a plurality of User Info fields of a trigger frame to indicate whether a resource unit (RU) adaptation is enabled for a plurality of STAs indicated by the plurality of User Info fields; and transmitting, by the AP, a physical layer protocol data unit (PPDU) including the trigger frame to the plurality of STAs.

In a second aspect, a method for UL MU transmission in a WLAN is provided. The method comprises: receiving, by an STA, a physical layer protocol data unit (PPDU) including a trigger frame from an AP, wherein a Common Info field or a plurality of User Info fields of the trigger frame are set to indicate whether a resource unit (RU) adaptation is enabled for a plurality of STAs indicated by the plurality of User Info fields, wherein the plurality of STAs include the STA; and decoding, by the STA, the received trigger frame to determine whether the RU adaptation is enabled for the STA.

In a third aspect, an access point (AP) for UL MU transmission in a WLAN. The AP comprises: a processor, a transceiver, and a memory configured to store computer programs, where the processor is configured to invoke and execute the computer programs stored in the memory to: set a Common Info field or a plurality of User Info fields of a trigger frame to indicate whether a resource unit (RU) adaptation is enabled for a plurality of STAs indicated by the plurality of User Info fields, and cause the transceiver to transmit a physical layer protocol data unit (PPDU) including the trigger frame to the plurality of STAs.

Other features and aspects of the disclosed features will become apparent from the following detailed description, taken in conjunction with the accompanying drawings, which illustrate, by way of example, the features in accordance with implementations of the disclosure. The summary is not intended to limit the scope of any implementations described herein.

### BRIEF DESCRIPTION OF THE DRAWINGS

The invention will be described in detail with reference to the accompanying drawings, in which:

FIG. 1 is a schematic view illustrating a trigger-based (TB) UL MU transmission according to the prior art.

FIG. 2A is a block diagram showing a format of an EHT MU PPDU according to various embodiments of the invention.

FIG. 2B is a block diagram showing a format of an EHT TB PPDU according to various embodiments of the invention.

FIG. 3A is a block diagram illustrating a format of a trigger frame according to various embodiments of the invention.

FIG. 3B is a block diagram illustrating a format of the Special User Info field according to various embodiments of the invention.

FIG. 4 is a flowchart illustrating a first method for UL MU transmission in a WLAN carried out by an AP according to various embodiments of the invention.

FIG. 5A is a block diagram illustrating a format of the Common Info field of the trigger frame according to a first embodiment of the invention.

FIG. 5B is a block diagram illustrating a format of the EHT variant User Info field according to the first embodiment.

FIG. 6A is a block diagram illustrating a format of the Common Info field of the trigger frame according to a second embodiment of the invention.

FIG. 6B is a block diagram illustrating a format of the EHT variant User Info field according to the second embodiment.

FIG. 6C is a block diagram illustrating a format of the EHT variant User Info field according to a third embodiment.

FIG. 7 is a flowchart illustrating a second method for UL MU transmission in a WLAN carried out by an STA according to various embodiments of the invention.

FIG. 8 is a flowchart illustrating a second method for UL MU transmission in a WLAN carried out by the STA if the RU adaptation is enabled for the STA according to some embodiments of the invention.

FIG. 9 is a schematic diagram illustrating an RU adaptation procedure performed by an STA according to one embodiment of the invention.

FIG. 10 is a schematic diagram illustrating a trigger-based UL MU transmission with a RU adaptation according to one embodiment of the invention.

FIG. 11 is a flowchart illustrating a first method for UL MU transmission in a WLAN carried out by an AP when the AP receives an EHT TB PPDU transmitted from an STA with RU adaptation enabled according to some embodiments of the invention.

FIG. 12 is a schematic diagram illustrating an AP according to some embodiments of the invention.

FIG. 13 is a schematic diagram illustrating an STA according to some embodiments of the invention.

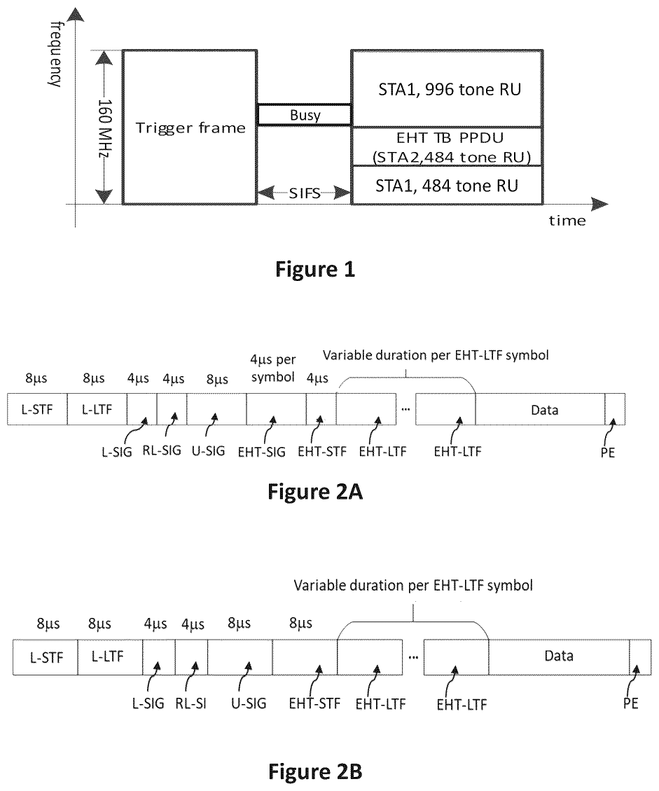

### DETAILED DESCRIPTION OF EMBODIMENTS OF THE INVENTION

In the following description, numerous specific details are set forth in order to provide a thorough understanding of various illustrative embodiments of the invention. It will be understood, however, to one skilled in the art, that embodiments of the invention may be practiced without some or all of these specific details. It is understood that the terminology used herein is for the purpose of describing particular embodiments only and is not intended to limit the scope of the invention.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

As used herein, the articles “a”, “an” and “the” as used with regard to a feature or element include a reference to one or more of the features or elements. As used herein, the term “and/or” includes any and all combinations of one or more of the associated listed items. As used herein, the terms “first,” “second,” and “third,” etc. are used merely as labels and are not intended to impose numerical requirements on their objects. As used herein, the term “configured to” is interchangeable with “operative” or “adapted to”.

As the methods and devices proposed in various embodiments of the invention may be used in IEEE 802.11be WLAN, possible formats of an EHT PPDU in IEEE 802.11be WLAN are described below first.

In IEEE 802.11be WLAN, an EHT PPDU may have any one of the following two formats: EHT MU PPDU and EHT TB PPDU. FIG. 2A is a block diagram showing a format of an EHT MU PPDU according to various embodiments of the invention. The EHT MU PPDU as shown in FIG. 2A is used for transmission to one or more users if the PPDU is not a response to a trigger frame from an AP STA. In an EHT MU PPDU, the Non-HT Short Training field (L-STF), Non-HT Long Training field (L-LTF), Non-HT Signal field (L-SIG), Repeated L-SIG (RL-SIG), Universal Signal field (U-SIG), and EHT Signal field (EHT-SIG) are called pre-EHT modulated fields while the EHT Short Training field (EHT-STF), EHT Long Training field (EHT-LTF), and data field are called EHT modulated fields. FIG. 2B is a block diagram showing a format of an EHT TB PPDU according to various embodiments of the invention. The EHT TB PPDU is used for a transmission that is a response to a trigger frame from an AP STA. In an EHT TB PPDU, the L-STF, L-LTF, L-SIG, RL-SIG, and U-SIG are called pre-EHT modulated fields while the EHT-STF, EHT-LTF, and data field are called EHT modulated fields. The duration of the EHT-STF in the EHT TB PPDU is twice the duration of the EHT-STF in the EHT MU PPDU. For an EHT PPDU, each EHT-LTF symbol has the same GI duration as each data symbol, which is 0.8 las, 1.6 μs, or 3.2 μs. The EHT-LTF comprises three types: lx EHT-LTF, 2×EHT-LTF and 4×EHT-LTF. The duration of each 1×EHT-LTF, 2×EHT-LTF, or 4×EHT-LTF symbol without GI is 3.2 μs, 6.4 μs, or 12.8 μs. Each data symbol without GI is 12.8 μs.

In various embodiments of the invention, RUs or MRUs which are larger than 242 tones and allowed for orthogonal frequency division multiple access (OFDMA) EHT PPDU include the following possible RUs or MRUs:
(1) 484 tone RUs applicable to 80 MHz, 160 MHz, or 320 MHz EHT PPDU;
(2) 242+484 tone MRUs applicable to 80 MHz, 160 MHz, or 320 MHz EHT PPDU;
(3) 996 tone RUs applicable to 160 MHz or 320 MHz EHT PPDU;
(4) 484+996 tone MRUs applicable to 160 MHz or 320 MHz EHT PPDU;
(5) 2×996 tone RUs applicable to 320 MHz EHT PPDU;
(6) 484+2×996 tone RUs applicable to 320 MHz EHT PPDU;
(7) 3×996 tone RUs applicable to 320 MHz EHT PPDU; and
(8) 484+3×996 tone RUs applicable to 320 MHz EHT PPDU.

In various embodiments of the invention, a RU or MRU which is larger than 242 tones and allowed for OFDMA EHT PPDU is associated with two or more child RUs or MRUs. Each of the associated child RUs or MRUs is a large-size RU or MRU, is allowed for OFDMA EHT PPDU, and has a size equal to or larger than 242 tones, but not larger than the RU or MRU.

A RU or MRU may be associated with a great number of child RUs or MRUs, which would increase implementation complexity. Some restrictions may be applied to reduce the number of child RUs or MRUs associated with a RU or MRU. In some embodiments, each child RU or MRU associated with a RU or MRU may have a size of at least X % of the size of the RU or MRU. In some examples, X may be a value in the range of 50 to 100, e.g. X=50. Some examples of the child RUs or MRUs associated with each RU or MRU larger than 242 tones and allowed for OFDMA EHT PPDU in case of X=50 are shown in Table 3A.

TABLE 3A

| RU or MRU | Associated Child RUs or MRUs |
|---|---|
| 484 tone RU | 484 tone RU (1) |
| | 242 tone RUs (2) |
| 242 + 484 tone MRU | 242 + 484 tone MRU (1) |
| | 484 tone RU (1) |
| 996 tone RU | 996 tone RU (1) |
| | 242 + 484 tone MRU (4) |
| | 484 tone RU (2) |
| 484 + 996 tone MRU | 484 + 996 tone MRU (1) |
| | 996 tone RU (1) |
| | 242 + 484 tone MRU (4) |
| 2 × 996 tone RU | 2 × 996 tone RU (1) |
| | 484 + 996 tone MRU (4) |
| | 996 tone RU (2) |
| 484 + 2 × 996 tone MRU | 484 + 2 × 996 tone MRU (1) |
| | 2 × 996 tone RU (1 or 0) |
| | 484 + 996 tone MRU (4 or 1) |
| 3 × 996 tone MRU | 3 × 996 tone MRU (1) |
| | 484 + 2 × 996 tone MRU (6 or 0) |
| | 2 × 996 tone RU (1) |
| | 484 + 996 tone MRU (4) |
| 484 + 3 × 996 tone MRU | 484 + 3 × 996 tone MRU (1) |
| | 3 × 996 tone MRU (1) |
| | 484 + 2 × 996 tone MRU (7 or 2) |
| | 2 × 996 tone RU (1) |

Referring to Table 3A, for a 484-tone RU, associated child RUs or MRUs include the 484-tone RU and two 242-tone RUs of the 484-tone RU; for a 242+484 tone MRU, associated child RUs or MRUs include the 242+484 tone MRU and the 484-tone RU of the 242+484 tone MRU; for a 996-tone RU, associated child RUs or MRUs include the 996-tone RU, four allowed 242+484 tone MRUs in the 996-tone RU, and two 484-tone RUs of the 996-tone RU; for a 484+996 tone MRU, associated child RUs or MRUs include the 484+996 tone MRU, the 996-tone RU of the 484+996 tone MRU, and four allowed 242+484 tone MRUs in the 996-tone RU of the 484+996 tone MRU; for a 2×996-tone RU, associated child RUs or MRUs include the 2×996-tone RU, two 996-tone RUs of the 2×996-tone RU and four allowed 484+996 tone MRUs in the 2×996-tone RU; for a 484+2×996 tone MRU in which two 996-tone RUs belong to a same 160 MHz frequency segment, associated child RUs or MRUs include the 484+2×996 tone RU, the 2×996-tone RU of the 484+2×996 tone MRU, and four allowed 484+996 tone MRUs in the 2×996-tone RU of the 484+2×996 tone MRU; for a 484+2×996 tone MRU in which two 996-tone RUs do not belong to the same 160 MHz frequency segment, associated child RUs or MRUs include the 484+2×996 tone MRU and the only allowed 484+996 tone MRU in the 484+2×996 tone MRU; for a 3×996-tone MRU in which three 996-tone RUs are contiguous, associated child RUs or MRUs include the 3×996-tone MRU, six allowed 484+2×996 tone MRUs in the 3×996-tone MRU, the 2×996-tone RU of the 3×996-tone MRU, and four allowed 484+996 tone MRUs in the 3×996-tone MRU; for a 3×996-tone MRU in which three 996-tone RUs are not contiguous, associated child RUs or MRUs include the 3×996-tone MRU, the 2×996-tone RU of the 3×996-tone MRU, and four allowed 484+996 tone MRUs in the 3×996-tone MRU; for a 484+3×996 tone MRU in which three 996-tone RUs are contiguous, associated child RUs or MRUs include the 484+3×996 tone MRU, the 3×996-tone MRU of the 484+3×996 tone MRU, seven allowed 484+2×996 tone MRUs in the 3×996-tone MRU and the 2×996-tone RU of the 484+3×996 tone MRU; for a 484+3×996 tone MRU in which three 996-tone RUs are not contiguous, associated child RUs or MRUs include the 484+3×996 tone MRU, the 3×996-tone MRU of the 484+3×996 tone MRU, two allowed 484+2×996 tone MRUs in the 484+3×996 tone MRU and the 2×996-tone RU of the 484+3×996 tone MRU.

Alternatively, in some other embodiments of the invention, each child RU or MRU associated with a RU or MRU may have a size of at least X %, e.g. X=50, of the size of the RU or MRU and the number of child RUs or MRUs associated with the RU or MRU is up to a predetermined value, e.g. 5. Some examples of the child RUs or MRUS associated with each RU or MRU which is larger than 242 tones and allowed for OFDMA EHT PPDU in case of X=50 and the predetermined value is 5 are shown in Table 3B.

TABLE 3B

| RU or MRU | Associated Child RUs or MRUs |
|---|---|
| 484-tone RU | 484-tone RU (1) |
| | 242-tone RUs (2) |
| 242 + 484-tone MRU | 242 + 484 tone MRU (1) |
| | 484-tone RU (1) |
| 996-tone RU | 996-tone RU (1) |
| | 242 + 484 tone MRU (4) |
| 484 + 996-tone MRU | 484 + 996 tone MRU (1) |
| | 996-tone RU (1) |
| | 242 + 484 tone MRU (3) |
| 2 × 996-tone RU | 2 × 996-tone RU (1) |
| | 484 + 996 tone MRU (4) |
| 484 + 2 × 996-tone MRU | 484 + 2 × 996 tone MRU (1) |
| | 2 × 996-tone RU (1 or 0) |
| | 484 + 996 tone MRU (3 or 1) |
| 3 × 996-tone MRU | 3 × 996-tone MRU (1) |
| | 484 + 2 × 996 tone MRU (4 or 0) |
| | 2 × 996-tone RU (0 or 1) |
| | 484 + 996 tone MRU (0 or 3) |
| 484 + 3 × 996-tone MRU | 484 + 3 × 996 tone MRU (1) |
| | 3 × 996-tone MRU (1) |
| | 484 + 2 × 996 tone MRU (3 or 2) |
| | 2 × 996-tone RU (0 or 1) |

Referring to Table 3B, for a 484-tone RU, associated child RUs or MRUs include the 484 tone RU and two 242 tone RUs of the 484 tone RU; for a 242+484 tone MRU, associated child RUs or MRUs include the 242+484 tone MRU and the 484-tone RU of the 242+484 tone MRU; for a 996-tone RU, associated child RUs or MRUs include the 996-tone RU and four allowed 242+484 tone MRUs in the 996-tone RU; for a 484+996 tone MRU, associated child RUs or MRUs comprise the 484+996 tone MRU, the 996-tone RU of the 484+996 tone MRU and any three of four allowed 242+484 tone MRUs in the 996-tone RU of the 484+996 tone MRU; for a 2×996-tone RU, associated child RUs or MRUs include the 2×996-tone RU and four allowed 484+996 tone MRUs in the 2×996-tone RU; for a 484+2×996 tone MRU in which two 996-tone RUs belong to a same 160 MHz frequency segment, associated child RUs or MRUs include the 484+2×996 tone RU, the 2×996-tone RU of the 484+2×996 tone MRU and any three of four allowed 484+996 tone MRUs in the 2×996-tone RU of the 484+2×996 tone MRU; for a 484+2×996 tone MRU in which two 996-tone RUs do not belong to the same 160 MHz frequency segment, associated child RUs or MRUs include the 484+2×996 tone MRU and the only allowed 484+996 tone MRU in the 484+2×996 tone MRU; for a 3×996-tone MRU in which three 996-tone RUs are contiguous, associated child RUs or MRUs include the 3×996-tone MRU and any four of six allowed 484+2×996 tone MRUs in the 3×996-tone MRU; for a 3×996-tone MRU in which three 996-tone RUs are not contiguous, associated child RUs or MRUs include the 3×996-tone MRU, the 2×996-tone RU of the 3×996-tone MRU and any three of four allowed 484+996 tone MRU in the 3×996-tone MRU; for a 484+3×996 tone MRU in which three 996-tone RUs are contiguous, associated child RUs or MRUs include the 484+3×996 tone MRU, the 3×996-tone MRU of the 484+3×996 tone MRU and any three of seven allowed 484+2×996 tone MRUs in the 484+3×996 tone MRU; for a 484+3×996 tone MRU in which three 996-tone RUs are not contiguous, associated child RUs or MRUs include the 484+3×996 tone MRU, the 3×996-tone MRU of the 484+3×996 tone MRU, two allowed 484+2×996 tone MRUs in the 484+3×996 tone MRU and the 2×996-tone RU of the 484+3×996 tone MRU.

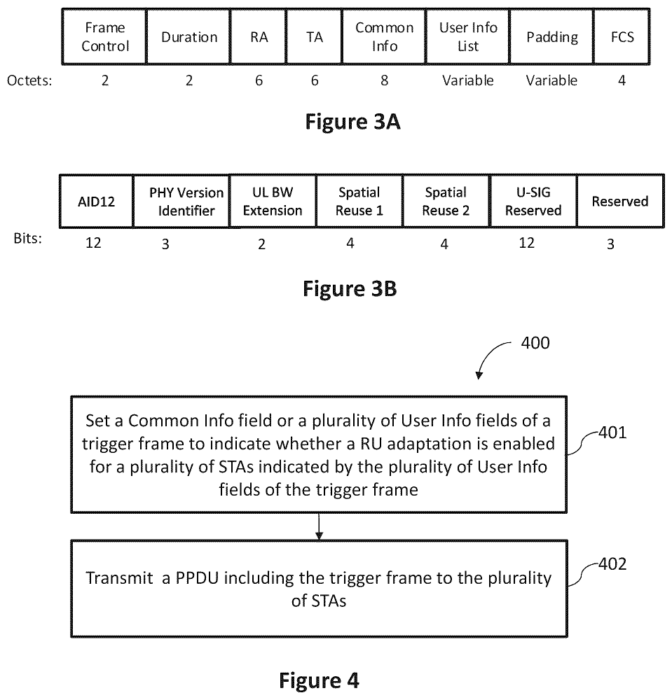

FIG. 3A is a block diagram illustrating a format of a trigger frame according to various embodiments of the invention. The trigger frame may include a Common Info field, a User Info List field, and a padding field. The padding field may be present in the trigger frame to extend the frame length to give the recipient STAs enough time to prepare a response for transmission of a SIFS after the trigger frame is received. The User Info List field may include one or more User Info fields. The formats of the Common Info field and the User Info fields may depend on the type of the trigger frame. The trigger frame may include three different types of User Info fields, i.e., HE variant User Info field, EHT variant User Info field, and Special User Info field. The Special User Info field is configured to carry necessary U-SIG subfields of the solicited EHT TB PPDUs. The Special User info field may be located immediately after the Common Info field in the trigger frame. FIG. 3B is a block diagram illustrating a format of the Special User Info field according to various embodiments of the invention, where the AID12 subfield of the Special User Info field shall be set to 2007.

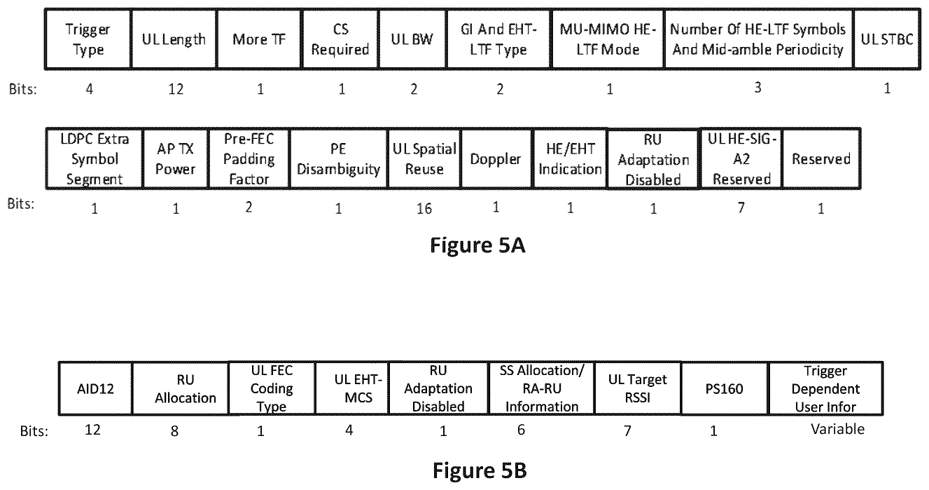

FIG. 4 is a flowchart illustrating a first method 400 for UL MU transmission in a WLAN carried out by an AP according to various embodiments of the invention.

At Block 401, the AP sets a Common Info field or a plurality of User Info fields of a trigger frame to indicate whether a RU adaptation is enabled for a plurality of STAs indicated by the plurality of User Info fields of the trigger frame.

At Block 402, the AP transmits a PPDU including the trigger frame to the plurality of STAs.

Three embodiments of the invention will be described below to illustrate three different formats of the trigger frame according to various embodiments of the invention. It should be noted that these embodiments are provided for illustrative purposes only, not to limit the scope of the invention.

### First Embodiment

In the first embodiment, the AP may set a subfield of the Common Info field of the trigger frame, e.g., a RU Adaptation Disabled subfield of the Common Info field, to indicate whether the RU adaptation is disabled for all of the plurality of STAs indicated by the plurality of the User Info fields of the trigger frame. The AP may further set the subfield of the Common Info field of the trigger frame, e.g., the RU Adaptation Disabled subfield of the Common Info field, to indicate that the RU adaptation is disabled for all of the plurality of STAs if RU or MRU allocated to any of the plurality of STAs is used for a multi-user multi-input multi-output (MU-MIMO) allocation.

FIG. 5A is a block diagram illustrating a format of the Common Info field of the trigger frame according to the first embodiment of the invention. As shown in FIG. 5A, the Common Info field may include a carrier sensing (CS) Required subfield, a UL bandwidth (BW) subfield, and a RU Adaptation Disabled subfield, i.e. the RU adaptation subfield. The UL BW subfield of the Common Info field along with the UL BW Extension subfield of the Special User Info field indicates the bandwidth in the U-SIG field of the EHT TB PPDU. The CS Required subfield indicates whether the STAs indicated by the plurality of User Info fields of the trigger frame are required to use energy detection (ED) to sense a medium and to consider a medium state and a network allocation vector (NAV) in determining whether or not to respond. In one example, the CS Required subfield may be set to 1 to indicate that the STAs indicated by the User Info fields are required to use ED to sense the medium and to consider the medium state and the NAV in determining whether or not to respond, or 0 to indicate that the STAs indicated by the User Info fields are not required to consider the medium state or the NAV in determining whether or not to respond. The RU Adaptation Disabled subfield is set to indicate whether RU adaptation is disabled for all of the STAs indicated by the User Info fields of the trigger frame. For example, the RU Adaptation Disabled subfield may be set to 1 to indicate that RU adaptation is disabled for all of the STAs indicated by the User Info fields, or 0 to indicate that the RU adaptation is enabled for all of the STAs indicated by the User Info fields. Further, in one example, when the CS Required subfield is set to 0 or the allocated RU or MRU for any of the STAs indicated by the User Info fields is used for an MU-MIMO allocation, the RU Adaptation Disabled subfield shall be set to 1.

FIG. 5B is a block diagram illustrating a format of the EHT variant User Info field according to the first embodiment. In the first embodiment, the RU Allocation subfield and the PS160 subfield in the EHT variant User Info field along with the UL BW subfield of the Common Info field and the UL BW Extension subfield of the Special User Info field are set to indicate the size and location of RU or MRU allocated for the STA indicated by the AID12 subfield of the EHT variant User Info field. The UL forward error correction (FEC) Coding Type subfield is set to indicate a coding type of the EHT TB PPDU to be transmitted by the STA. The UL FEC Coding Type subfield may be set to 0 to indicate binary convolutional coding (BCC) or set to 1 to indicate a low density parity check (LDPC).

According to the first embodiment, in one example, an STA may perform a RU adaptation procedure when the RU Adaptation Disabled subfield of the Common Info field in the received trigger frame is set to 0. An STA shall not perform a RU adaptation procedure when the RU Adaptation Disabled subfield of the Common Info field in a soliciting trigger frame is set to 1 or when the allocated RU or MRU for the STA is not larger than 242 tones even if the RU Adaptation Disabled subfield of the Common Info field in a soliciting trigger frame is set to 0.

In the second and the third embodiments, the AP may set a first subfield of a first User Info field of the trigger frame, to indicate whether the RU adaptation is enabled for a first STA indicated by the first User Info field if RU or MRU allocated to the first STA is larger than 242 tones, wherein the RU or MRU is indicated in a second subfield and a third subfield of the first User Info field. Further, the AP may be configured to set the first subfield of the first User Info field of the trigger frame to indicate that the RU adaptation is disabled for the first STA if the RU or MRU allocated to the first STA is used for an MU-MIMO allocation, or a carrier sensing (CS) required subfield of the Common Info field of the trigger frame is set to indicate that the plurality of STAs including the first STA are not required to use ED to sense medium and to consider a medium state and a NAV in determining whether or not to respond.

### Second Embodiment

In the second embodiment, the first user field of the trigger frame may be an EHT variant User Info field of the trigger frame, and the first subfield may be a RU Adaptation Disabled subfield in the EHT variant User Info field. Accordingly, the second and the third subfield may be the RU Allocation and PS160 subfields respectively in the EHT variant User Info field.

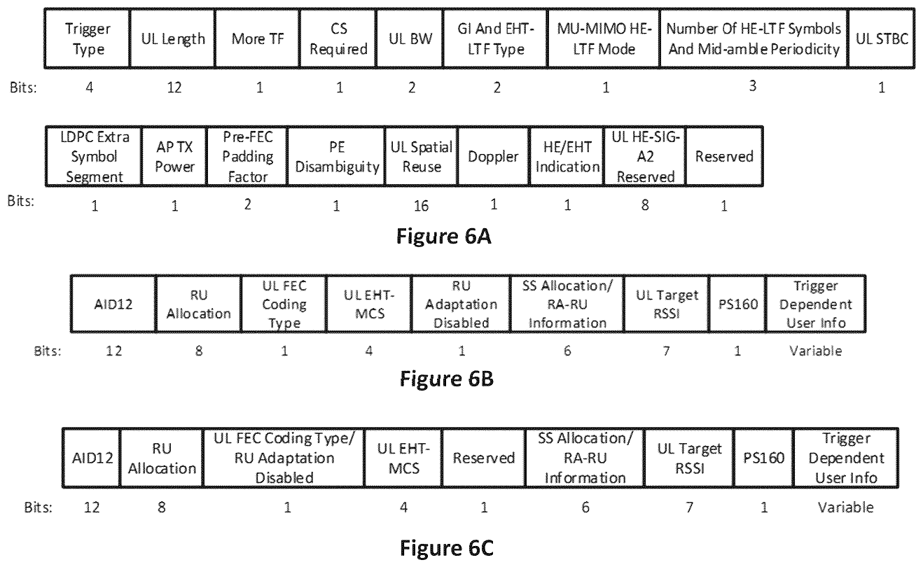

FIG. 6A is a block diagram illustrating a format of the Common Info field of the trigger frame according to the second embodiment of the invention. As shown in FIG. 6A, the Common Info field may include a CS Required subfield and a UL BW subfield. The UL BW subfield of the Common Info field along with the UL BW Extension subfield of the Special User Info field indicates the bandwidth in the U-SIG field of the solicited EHT TB PPDU. The CS Required subfield indicates whether the STAB identified in the User Info fields are required to use ED to sense a medium and to consider a medium state and a NAV in determining whether or not to respond. The CS Required subfield may be set to 1 to indicate that the STAB indicated by the plurality of User Info fields of the trigger frame are required to use ED to sense the medium and to consider the medium state and the NAV in determining whether or not to respond; or 0 to indicate that the STAB indicated by the User Info fields are not required to consider the medium state or the NAV in determining whether or not to respond.

FIG. 6B is a block diagram illustrating a format of the EHT variant User Info field according to the second embodiment. Referring to FIG. 6B, a RU Allocation subfield and a PS160 subfield along with the UL BW subfield of the Common Info field and the UL BW Extension of the Special User Info field are set to indicate the size and location of RU or MRU allocated for the STA indicated by the AID12 subfield of the EHT variant User Info field. The UL FEC Coding Type subfield is set to indicate a coding type of the EHT TB PPDU to be transmitted by the STA. The UL FEC Coding Type subfield may be set to 0 to indicate BCC or set to 1 to indicate LDPC. The RU Adaptation Disabled subfield is set to indicate whether RU adaptation is disabled for the STA indicated by the AID12 subfield. The RU Adaptation Disabled subfield may be set to 1 to indicate RU adaptation is disabled for the STA indicated by the AID12 subfield, or 0 to indicate RU adaptation is enabled for the STA indicated by the AID12 subfield. Further, in one example, when the allocated RU or MRU for the STA is not larger than 242 tones, the allocated RU or MRU for the STA is used for an MU-MIMO allocation, or the CS Required subfield of the Common Info field is set to 0, the RU Adaptation Disabled subfield shall be set to 1. According to the second embodiment, in one example, an STA may perform a RU adaptation procedure when the RU Adaptation Disabled subfield of the User Info field for the STA in the received Trigger frame is set to 0. An STA shall not perform a RU adaptation procedure when the RU Adaptation Disabled subfield of the User Info field for the STA in the received Trigger frame is set to 1.

### Third Embodiment

In the third embodiment, the first user field of the trigger frame may be an EHT variant User Info field of the trigger frame, and the first subfield, different from the second embodiment, may be a UL FEC Coding Type/RU Adaptation Disabled subfield. In this embodiment, the UL FEC Coding Type subfield and the RU Adaptation Disabled subfield in the second embodiment are combined in one subfield. In this embodiment, the AP may be further configured to set the first subfield of the first User Info field of the trigger frame to indicate a coding type of an EHT TB PPDU to be transmitted by the first STA if the RU or MRU allocated to the first STA is less than or equal to 242 tones.

In the third embodiment, the Common Info field of the Trigger frame may have the same format as that according to the second embodiment as illustrated in FIG. 6A. FIG. 6C is a block diagram illustrating a format of the EHT variant User Info field according to the third embodiment. Referring to FIG. 6C, the RU Allocation subfield and the PS160 subfield along with the UL BW subfield of the Common Info field and the UL BW Extension subfield of the Special User Info field are set to indicate the size and location of RU or MRU allocated for the STA indicated by the AID12 subfield.

It should be noted that RU adaptation is not applicable to the allocated RU or MRU which is less than or equal to 242 tones, and BCC is not applicable to the allocated RU or MRU which is larger than 242 tones. According to the third embodiment, how the UL FEC Coding Type/RU Adaptation Disabled subfield for an STA is set depending on the size of the allocated RU or MRU for the STA. When the allocated RU or MRU is less than or equal to 242 tones, the UL FEC Coding Type/RU Adaptation Disabled subfield indicates a coding type of the EHT TB PPDU to be transmitted by the STA. In one example, the UL FEC Coding Type/RU Adaptation Disabled subfield may be set to 0 to indicate BCC or set to 1 to indicate LDPC. When the allocated RU or MRU is larger than 242 tones, the UL FEC Coding Type/RU Adaptation Disabled subfield may be set to indicate whether RU adaptation is disabled for the STA indicated by the AID12 subfield. The UL FEC Coding Type/RU Adaptation Disabled subfield may be set to 1 to indicate RU adaptation is disabled for the STA indicated by the AID12 subfield or set to 0 to indicate RU adaptation is enabled for the STA indicated by the AID12 subfield. In this example, when the allocated RU or MRU for the STA is used for an MU-MIMO allocation, or the CS Required subfield of the Common Info field is set to 0, the UL FEC Coding Type/RU Adaptation Disabled subfield shall be set to 1.

According to the third embodiment, in one example, an STA may perform a RU adaptation procedure when the allocated RU or MRU is larger than 242 tones and the UL FEC Coding Type/RU Adaptation Disabled subfield of the User Info field for the STA in the received Trigger frame is set to 0. An STA shall not perform a RU adaptation procedure when the allocated RU or MRU is larger than 242 tones and the UL FEC Coding Type/RU Adaptation Disabled subfield of the User Info field for the STA in the received Trigger frame is set to 1.

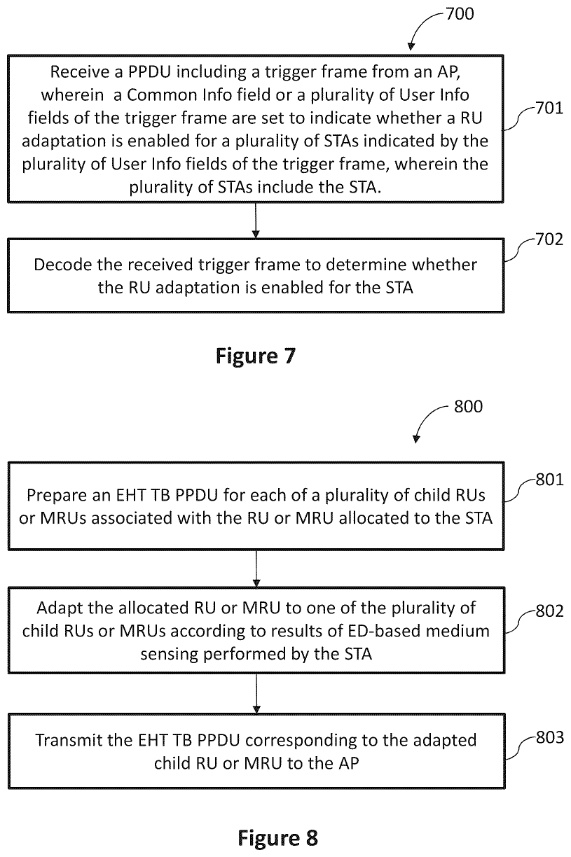

FIG. 7 is a flowchart illustrating a second method 700 for UL MU transmission in a WLAN carried out by an STA according to various embodiments of the invention.

At Block 701, STA receives a PPDU including a trigger frame from an AP, wherein a Common Info field or a plurality of User Info fields of the trigger frame are set to indicate whether a RU adaptation is enabled for a plurality of STAs indicated by the plurality of User Info fields of the trigger frame, wherein the plurality of STAs include the STA.

At Block 702, STA decodes the received trigger frame to determine whether the RU adaptation is enabled for the STA.

If the trigger frame in the first embodiment is received by the STA, the STA further decodes the Common Info field of the trigger frame to determine whether the RU adaptation is enabled for the STA, wherein the Common Info field is set to indicate whether the RU adaptation is enabled for all of the plurality of STAs indicated by the plurality of User Info fields of the trigger frame. Further, the STA may decode the Common Info field of the trigger frame to determine that the RU adaptation is disabled for the STA, wherein the Common Info field is set to indicate that the RU adaptation is disabled for all of the plurality of STAs when RU or MRU allocated to any of the plurality of STAs is used for a multi-user multi-input multi-output (MU-MIMO) allocation.

If the trigger frame in the second embodiment is received by the STA, the STA may further decode a first subfield, e.g. the RU Adaptation Disabled subfield, of a first User Info field whose AID12 subfield matches the STA's association identifier (AID), e.g. the EHT variant User Info field, of the trigger frame to determine whether the RU adaptation is enabled for the STA, wherein the first subfield is set to indicate whether the RU adaptation is enabled for the STA when RU or MRU allocated to the STA is larger than 242 tones.

Further, the RU Adaptation Disabled subfield may be set to indicate that the RU adaptation is disabled for the STA if the RU or MRU allocated to the STA is used for an MU-MIMO allocation, or a carrier sensing (CS) Required subfield of the Common Info field of the trigger frame is set to indicate that the plurality of STAs including the STA are not required to use energy detection (ED) to sense medium and to consider a medium state and a network allocation vector (NAV) in determining whether or not to respond. In one example, the STA may determine that the RU adaptation is disabled for the STA if the RU Adaptation Disabled subfield is set to 1, or determine that the RU adaptation is enabled for the STA if the RU Adaptation Disabled subfield is set to 0.

If the trigger frame in the third embodiment is received by the STA, the STA may further decode the first subfield of the first User Info field whose AID12 subfield matches the STA's AID, e.g. the UL FEC Coding Type/RU Adaptation Disabled subfield of the EHT variant User Info field, to obtain a coding type of an EHT TB PPDU to be transmitted by the STA.

In some embodiments, when an STA receives a trigger frame from an AP and determines to perform a RU adaptation procedure after decoding a User Info field for the STA in the received Trigger frame, the RU or MRU allocated to the STA may be adapted to one of a plurality of child RUs or MRUs associated with the RU or MRU allocated to the STA according to results of ED-based medium sensing performed by the STA. When part of the allocated RU or MRU which is considered idle matches one of the associated child RUs or MRUs, the allocated RU or MRU is adapted to the one of the associated child RUs or MRUs. When part of the allocated RU or MRU which is considered idle does not match any of the associated child RUs or MRUs but covers at least one of the associated child RUs or MRUs, the allocated RU or MRU is adapted to one of the associated child RUs or MRUs which overlaps with the part of the allocated RU or MRU to the most extent. Further, when part of the allocated RU or MRU which is considered idle does not match or cover any of the associated child RUs or MRUs, the allocated RU or MRU will not be adapted to any of the associated child RUs or MRUs.

FIG. 8 is a flowchart illustrating a second method 800 for UL MU transmission in a WLAN carried out by the STA if the RU adaptation is enabled for the STA according to some embodiments of the invention.

At Block 801, STA prepares an EHT TB PPDU for each of a plurality of child RUs or MRUs associated with the RU or MRU allocated to the STA.

At Block 802, STA adapts the allocated RU or MRU to one of the plurality of child RUs or MRUs according to results of ED-based medium sensing performed by the STA.

At Block 803, STA transmits the EHT TB PPDU corresponding to the adapted child RU or MRU to the AP.

It should be noted that an STA needs to start preparing an EHT TB PPDU for each of a plurality of child MRUs associated with the RU or MRU allocated to the STA before the STA carries out medium sensing since the STA may not have enough time to sense the medium and then prepare an EHT TB PPDU according to the adapted RU or MRU within the SIFS after receiving the soliciting Trigger frame.

STA may further set an adapted MCS and/or a count number of spatial streams (Nss) in a U-SIG field of the EHT TB PPDU corresponding to the adapted child RU or MRU.

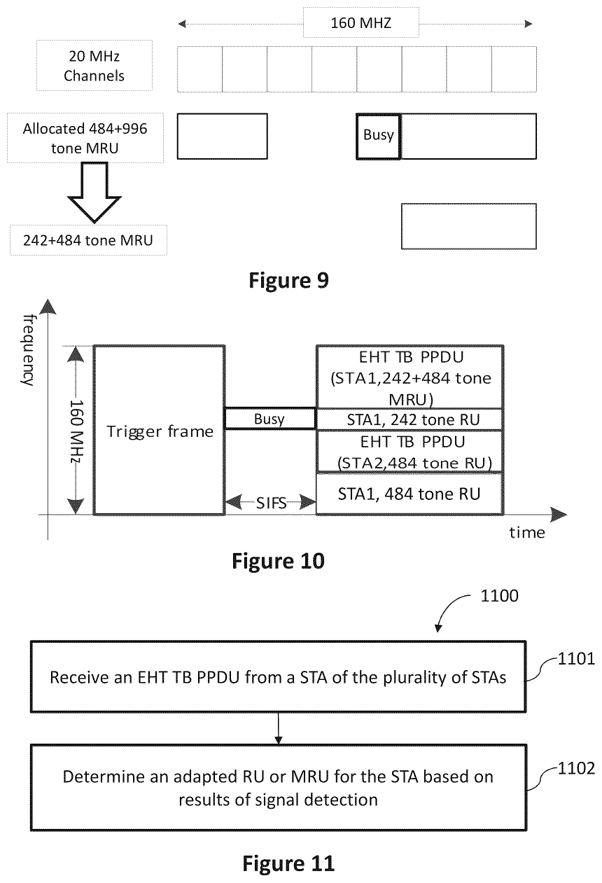

FIG. 9 is a schematic diagram illustrating an RU adaptation procedure performed by an STA according to one embodiment of the invention. In this embodiment, a 484+996 tone MRU is allocated to the STA for 160 MHz EHT TB PPDU transmission. The second MHz channel within the allocated 484+996 tone MRU is considered busy based on the results of ED-based medium sensing performed by the STA. Therefore, the allocated 484+996 tone MRU is adapted to one of the associated child RUs or MRUs, i.e. the 242+484 tone MRU, overlapping with the idle part of the allocated 484+996 tone MRU to the most extent.

FIG. 10 is a schematic diagram illustrating a trigger-based UL MU transmission with a RU adaptation according to one embodiment of the invention. Referring to Figure in this embodiment, an AP may transmit a trigger frame to solicit simultaneous 160 MHz EHT TB PPDU transmissions from two STAs, i.e., STA1 and STA2. The trigger frame indicates the following: one 484+996 tone MRU is allocated to STA1 and one 484 tone RU is allocated to STA2; STA1 and STA2 shall use ED to sense the medium and to consider the medium state and the NAV in determining whether or not to respond, and RU adaptation is enabled for both STA1 and STA2. In this embodiment, each of STA1 and STA2 shall perform the ED at least in the subchannel that contains its UL allocation during the SIFS after receiving the PPDU that includes the trigger frame, where the sensed subchannels for STA1 and STA2 consist of six 20 MHz channels and two 20 MHz channels, respectively. The PPDU including the trigger frame may be a non-HT PPDU, an HT PPDU, a VHT PPDU, a HE PPDU, or an EHT PPDU. STA2 detects that the two 20 MHz channels including the allocated 484 tone RU are all idle, and thus STA2 transmits an EHT TB PPDU to the AP. STA1 detects that one of the six 20 MHz channels containing the allocated 484+996 tone MRU is busy; and STA1 may adapt the allocated 484+996 tone MRU to one of the associated child 242+484 tone MRUs and then transmit an EHT TB PPDU at the adapted 242+484 tone MRU to the AP. As a result, the whole allocated 484+996 tone MRU for STA1 is not wasted and system throughput is improved.

In some embodiments, if the allocated RU or MRU for an STA is adapted to one of its associated child RUs or MRUs, the MCS indicated in the UL EHT-MCS subfield and/or the number of spatial streams (Nss) indicated in the SS Allocation/RA-RU Information subfield in the User Info field for the STA may be adapted accordingly. The adapted MCS and/or NSS may be indicated in the U-SIG field of the EHT TB PPDU to be transmitted by the STA.

FIG. 11 is a flowchart illustrating the first method 1100 for UL MU transmission in a WLAN carried out by an AP when the AP receives an EHT TB PPDU transmitted from an STA with RU adaptation enabled according to some embodiments of the invention.

At Block 1101, the AP receives an EHT TB PPDU from an STA, i.e. the second STA, of the plurality of STAs.

At Block 1102, the AP determines an adapted RU or MRU for the STA based on results of signal detection, wherein the adapted RU or MRU for the STA includes one of a plurality of child RUs or MRUs associated with the RU or MRU allocated to the STA.

The AP may further determine adapted MCS and/or Nss for the STA from a U-SIG field in the EHT TB PPDU from the STA. As mentioned above, each of the plurality of child RUs or MRUs associated with the RU or MRU allocated to the STA may have a size of at least X % of a size of the RU or MRU allocated to the STA, wherein the X may be in a range of 50 to 100, e.g. X may be 50. Further, the number of the child RUs or MRUs associated with the RU or MRU allocated to the STA may be not greater than a predetermined value, e.g. 5.

In some embodiments, when receiving an EHT TB PPDU transmitted by an STA with RU adaptation enabled, the AP may decode the received EHT TB PPDU according to the following procedure: signal detection is performed using one or more of pre-EHT modulated fields of the EHT TB PPDU transmitted in all 20 MHz channels containing the allocated RU or MRU for the STA. Based on signal detection results, the AP is able to determine the adapted RU or MRU for the STA. For the example illustrated in FIG. 8 where the allocated 484+996 tone MRU for STA1 is adapted to the 242+484 tone MRU when the AP receives an EHT TB PPDU transmitted by STA1, a signal would be detected by the AP in all three 20 MHz channels containing the 242+484 tone MRU and thus the AP can properly determine the adapted 242+484 tone MRU for STA1. Further, the AP may determine the adapted MCS and/or Nss from the U-SIG field of the EHT TB PPDU from STA1. The remaining EHT TB PPDU is then decoded by the AP according to the adapted RU or MRU, MCS, and/or Nss.

It is appreciated by a person skilled in the art that in some embodiments of the invention, an STA may not have enough time to prepare an EHT TB PPDU within the SIFS after receiving the soliciting trigger frame from an AP. To address this issue, a minimum trigger frame processing time required by the STA may be indicated in an HE Capabilities element and/or an EHT Capabilities element to inform the AP.

At the STA side, an STA may indicate the minimum trigger frame processing time required by the STA depending on whether the RU adaptation is enabled for the STA. The minimum trigger frame processing time required by the STA when the RU adaptation is enabled for the STA should not be less than that required by the STA when the RU adaptation is disabled for the STA.

In some embodiments, the STA may indicate a first time period and a second time period in an HE Capabilities element and/or an EHT Capabilities element, wherein the minimum trigger frame processing time required by the STA may be determined based on the first time period and/or the second time period. In one embodiment, the STA may indicate the first time period in the HE Capabilities element, and the second time period in the EHT Capabilities element; while in another embodiment, alternatively, the STA may indicate both the first time period and the second time period in the EHT Capabilities element. In some embodiments, the first time period may be set to indicate the minimum trigger frame processing time required by the STA when the RU adaptation is not enabled for the STA, while the second time period may be set to indicate the minimum trigger frame processing time required by the STA when the RU adaptation is enabled for the STA. Alternatively, in some other embodiments, the first time period may be set to indicate the minimum trigger frame processing time required by the STA when the RU adaptation is not enabled for the STA, while the second time period may be set to indicate an additional time period required by the STA when the RU adaptation is enabled for the STA, i.e. the minimum trigger frame processing time required by the STA when the RU adaptation is enabled may be calculated based on both the first time period and the second time period, e.g. the minimum trigger frame processing time required by the STA when the RU adaptation is enabled is a sum of the first time period and the second time period.

At the AP side, the AP may apply a MAC padding to the PPDU to be transmitted to the STAs to satisfy the minimum trigger frame processing time required by any one of the plurality of STAs depending on whether the RU adaptation is enabled for the STA. In some embodiments, the AP may determine a minimum trigger frame processing time required by the STA based on the first time period and/or the second time period indicated in an HE Capabilities element and/or an EHT Capabilities element from the STA. In some embodiments, the first time period may be indicated in the HE Capabilities element, and the second time period may be indicated in the EHT Capabilities element. Alternatively, in some other embodiments, both the first time period and the second time period may be indicated in the EHT Capabilities element. In some embodiments, the AP may determine the minimum trigger frame processing time required by the STA is equal to the first time period if the RU adaptation is disabled for the STA; or equal to the second time period if the RU adaptation is enabled for the STA. In some other embodiments, the AP may determine that the minimum trigger frame processing time required by the STA is equal to the first time period if the RU adaptation is disabled for the STA; or a sum of the first and the second time periods if the RU adaptation is enabled for the STA.

In some embodiments of the invention, the STA may prepare an EHT TB PPDU for each of the child RUs or MRUs associated with the allocated RU or MRU for the STA after identifying a User Info field for the STA in the received Trigger frame from an AP. If the allocated RU or MRU for the STA is adapted to one of its associated child RU or MRU according to the results of ED-based medium sensing performed by the STA, the STA selects one of the prepared EHT TB PPDUs which corresponds to the adapted child RU or MRU and transmits it to the AP. On the other hand, if the allocated RU or MRU for the STA is not adapted to any of its associated child RUs or MRUs according to the results of ED-based medium sensing performed by the STA, the STA will not transmit any EHT TB PPDU to the AP.

According to some embodiments of the invention, the minimum Trigger frame processing time, i.e., MinTrigProcTime, required by an STA depends on whether or not a RU adaptation procedure is performed by the STA. Since an STA performing RU adaptation needs to prepare an EHT TB PPDU for each of child RUs or MRUs associated with RU or MRU allocated to the STA, the MinTrigProcTime required by an STA performing RU adaptation shall not be less than the MinTrigProcTime required by the STA not performing RU adaptation. For example, the MinTrigProcTime required by an STA not performing RU adaptation may be 16 μs, while the MinTrigProcTime required by an STA performing RU adaptation may be 32 μs.

In one embodiment, the STA may indicate a first nominal MinTrigProcTime, i.e., the first time period, and a second nominal MinTrigProcTime, i.e. the second time period, in the HE MAC Capabilities Information field of the HE Capabilities element and/or the EHT MAC Capabilities Information field of the EHT Capabilities element, which may be carried in a Probe Request frame, an Association Request frame or a Reassociation Request frame transmitted by the STA to the AP. In a first example, the first nominal MinTrigProcTime is indicated in the HE MAC Capabilities Information field of the HE Capabilities element and the second nominal MinTrigProcTime is indicated in the EHT MAC Capabilities Information field of the EHT Capabilities element. In a second example, both the first nominal MinTrigProcTime and the second nominal MinTrigProcTime are indicated in the EHT MAC Capabilities Information field of the EHT Capabilities element. In one embodiment, the MinTrigProcTime required by an STA not performing RU adaptation is the first nominal MinTrigProcTime; and the MinTrigProcTime required by an STA performing RU adaptation is a sum of the first nominal MinTrigProcTime and the second nominal MinTrigProcTime. In another embodiment, the MinTrigProcTime required by an STA not performing RU adaptation is the first nominal MinTrigProcTime; and the MinTrigProcTime required by an STA performing RU adaptation is the second nominal MinTrigProcTime.

According to some embodiments, an AP transmitting a PPDU that includes a BCC encoded Trigger frame to solicit a response from an STA shall ensure that the number of bits in the PSDU following the last bit of SCH is at least equal to L_{PAD, MAC} as defined in Equation (1), where SCH is the User Info field addressed to the STA of the Trigger frame

L_{PAD,MAC}=N_{DBPS}×m_{PAD} (1)

where N_{DBPS} is the number of data bits per OFDM symbol for the STA. For the trigger frame carried in a non-HT PPDU, HT PPDU, and VHT PPDU, m_{PAD} is as defined in Equation (2); for the trigger, frame carried in an HE PPDU or an EHT PPDU, m_{PAD} is as defined in Equation (3).

$${m}_{PAD} = ⌈ \frac{MinTrigProcTime}{4} ⌉ \qquad ( 2 )$$

$${m}_{PAD} = ⌈ \frac{MinTrigProcTime}{16} ⌉ \qquad ( 3 )$$

In Equation (2) and (3), the MinTrigProcTime has a unit of microsecond.

In some embodiments, an AP may use any type of MAC padding to satisfy the MinTrigProcTime requirement of an STA, such as using the Padding field in a trigger frame, post-EOF A-MPDU padding, or aggregating other MPDUs in an A-MPDU.

In some embodiments, if a trigger frame is LDPC encoded, then the AP may ensure that T_{TrigProc}, which is the duration of PPDU that is after the OFDM symbol containing the last coded bit of the LDPC codeword that encodes the last bit of SCH minus the nominal PE field duration, i.e. T_{PE, nominal}, shall be greater than or equal to the MinTrigProcTime required by the STAs that are the recipients of the trigger frame.

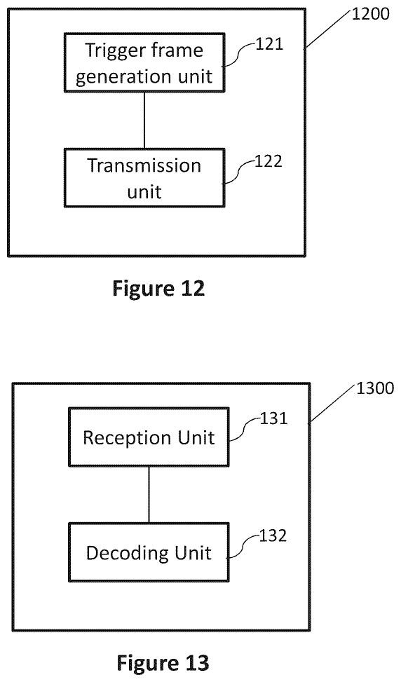

Various embodiments of the invention also provide an AP for UL MU transmission in a WLAN. FIG. 12 is a schematic diagram illustrating an AP 1200 according to some embodiments of the invention. Referring to FIG. 12, the AP 1200 may include a trigger frame generation unit 121 configured to set a Common Info field or a plurality of User Info fields of a trigger frame to indicate whether a resource unit (RU) adaptation is enabled for a plurality of STAs indicated by the plurality of User Info fields; and a transmission unit 122 configured to transmit a physical layer protocol data unit (PPDU) including the trigger frame to the plurality of STAs.

In some embodiments, the trigger frame generation unit 121 may be further configured to set a subfield, e.g. the RU Adaptation Disabled subfield shown in FIG. 5A, of the Common Info field of the trigger frame to indicate whether the RU adaptation is enabled for all of the plurality of STAs indicated by the plurality of User Info fields of the trigger frame. Further, the trigger frame generation unit may be further configured to set the subfield of the Common Info field of the trigger frame to indicate that the RU adaptation is disabled for all of the plurality of STAs if RU or MRU allocated to any of the plurality of STAs is used for an MU-MIMO allocation.

In some embodiments, the trigger frame generation unit 121 may be further configured to set a first subfield of a first User Info field of the trigger frame to indicate whether the RU adaptation is enabled for a first STA indicated by the first User Info field s is larger than 242 tones, wherein the RU or MRU is indicated in a second subfield and a third subfield of the first User Info field. Further, the trigger frame generation unit 121 may be configured to set the first subfield of the first User Info field of the trigger frame to indicate that the RU adaptation is disabled for the first STA if the RU or MRU allocated to the first STA is used for an MU-MIMO allocation, or a CS required subfield of the Common Info field of the trigger frame is set to indicate that the plurality of STAs including the first STA are not required to use ED to sense medium and to consider a medium state and a NAV in determining whether or not to respond. If the RU or MRU allocated to the first STA is less than or equal to 242 tones, the trigger frame generation unit 121 may be further configured to set the first subfield of the first User Info field of the trigger frame to indicate a coding type of an EHT TB PPDU to be transmitted by the first STA.

In some embodiments, if the RU adaptation is enabled for a second STA, i.e. any STA of the plurality of STAs, of the plurality of STAs indicated by the User Info fields of the trigger frame, the AP 1200 may further include a reception unit configured to receive an EHT TB PPDU from a second STA of the plurality of STAs; and an adaptation unit configured to determine an adapted RU or MRU for the second STA based on results of signal detection, wherein the adapted RU or MRU for the second STA includes one of a plurality of child RUs or MRUs associated with the RU or MRU allocated to the second STA. The adaptation unit may be further configured to obtain an adapted MCS and/or Nss for the second STA from a U-SIG field in the EHT TB PPDU from the second STA.

In some embodiments, the AP 1200 may further include a trigger frame (TF) processing time determination unit configured to apply a MAC padding to the PPDU to satisfy a minimum trigger frame processing time required by any one of the plurality of STAs depending on whether the RU adaptation is performed by the STA. Further, the TF processing time determination unit may be further configured to determine the minimum trigger frame processing time required by the STA based on a first time period and/or a second time period indicated in an HE Capabilities element and/or an EHT Capabilities element carried in a Probe Request frame, an Association Request frame or a Reassociation Request frame transmitted from the STA to the AP 120.

In some embodiments, the TF processing time determination unit may be further configured to obtain the first time period from the HE Capabilities element and obtain the second time period from the EHT Capabilities element, or obtain both the first time period and the second time period from the EHT Capabilities element.

In some embodiments, the TF processing time determination unit is further configured to determine that the minimum trigger frame processing time required by the STA is equal to the first time period if the RU adaptation is disabled for the STA; or equal to the second time period if the RU adaptation is enabled for the STA. Alternatively, in some other embodiments, the TF processing time determination unit may be further configured to determine that the minimum trigger frame processing time required by the STA is equal to the first time period if the RU adaptation is disabled for the STA; or equal to a sum of the first and the second time periods if the RU adaptation is enabled for the STA.

Various embodiments of the invention also provide an STA for UL MU transmission. FIG. 13 is a schematic diagram illustrating an STA 1300 according to some embodiments of the invention. The STA 1300 may include a reception unit 131 configured to receive a physical layer protocol data unit (PPDU) including a trigger frame from an AP, wherein a Common Info field or a plurality of User Info fields of the trigger frame are set to indicate whether a resource unit (RU) adaptation is enabled for a plurality of STAs indicated by the plurality of User Info fields, wherein the plurality of STAs include the STA 1300; and a decoding unit 132 configured to decode the trigger frame to determine whether the RU adaptation is enabled for the STA 1300.

In some embodiments, a subfield, e.g. RU Adaptation Disabled subfield shown in FIG. 5A, of the Common Info field may be set to indicate whether the RU adaptation is enabled for all of the plurality of STAs indicated by the plurality of User Info fields of the trigger frame, wherein the decoding unit 132 may be further configured to decode the subfield of the Common Info field, e.g. the RU Adaptation Disabled subfield shown in FIG. 5A, to determine whether the RU adaptation is enabled for the STA 1300. Further, if RU or MRU allocated to any of the plurality of STAs is used for an MU-MIMO allocation, the subfield of the Common Info field, may be set to indicate that the RU adaptation is disabled for all of the plurality of STAs, accordingly the decoding unit 132 may be further configured to decode the subfield of the Common Info field to determine that the RU adaptation is disabled for the STA 1300.

In some embodiments, if RU or MRU allocated to the STA 1300 is larger than 242 tones, a first subfield of a first User Info field of the trigger frame may be set to indicate whether the RU adaptation is enabled for the STA 1300 indicated by the first User Info field, accordingly the decoding unit 132 may be further configured to decode the first subfield to determine whether the RU adaptation is enabled for the STA 1300. Further, if the RU or MRU allocated to the STA 1300 is used for an MU-MIMO allocation, or a CS required subfield of the Common Info field of the trigger frame is set to indicate that the plurality of STAs including the STA 1300 are not required to use ED to sense medium and to consider a medium state and a NAV in determining whether or not to respond, the first subfield may be set to indicate that the RU adaptation is disabled for the STA 1300, accordingly the decoding unit 132 may be further configured to decode the first subfield to determine that the RU adaptation is disabled for the STA 1300.

In some embodiments, if the RU or MRU allocated to the STA 1300 is less than or equal to 242 tones, the first subfield may be further set to indicate a coding type of an EHT TB PPDU to be transmitted by the STA 1300, accordingly, the decoding unit 132 may be further configured to decode the first subfield to obtain the coding type of the EHT TB PPDU to be transmitted by the STA 1300.

In some embodiments, if the RU adaptation is enabled for the STA 1300, the STA 1300 may further include a data unit preparation unit configured to prepare an EHT TB PPDU for each of a plurality of child RUs or MRUs associated with RU or MRU allocated to the STA 1300; an adaptation unit configured to adapt the allocated RU or MRU to one of the plurality of child RUs or MRUs according to results of ED-based medium sensing performed by the STA 1300, and a transmission unit configured to transmit the EHT TB PPDU corresponding to the adapted child RU or MRU to the AP. In some embodiments, the data unit preparation unit may be further configured to set an adapted MCS and/or a count number of spatial streams (Nss) in a U-SIG field of the EHT TB PPDU corresponding to the adapted child RU or MRU.

In some embodiments, to make sure that the STA 1300 has enough time to use ED to sense medium, perform the RU adaptation and prepare an EHT TB PPDU according to the adapted RU or MRU within the SIFS after receiving the soliciting trigger frame, the STA 1300 may further include a TF processing time indication unit configured to indicate, in an HE Capabilities element and/or an EHT Capabilities element carried in a Probe Request frame, an Association Request frame or a Reassociation Request frame to be transmitted to the AP, a minimum trigger frame processing time required by the STA depending on whether the RU adaptation is performed by the STA 1300.

In some embodiments, the TF processing time indication unit may be further configured to indicate a first time period and a second time period in the HE Capabilities element and/or the EHT Capabilities element, wherein the minimum trigger frame processing time required by the STA 1300 is determined based on the first time period and the second time period. In some embodiments, the TF processing time indication unit may be configured to indicate the first time period in the HE Capabilities element, and the second time period in the EHT Capabilities element, or indicate both the first time period and the second time period in the EHT Capabilities element.

In one embodiment, the TF processing time indication unit may be further configured to indicate the first time period to be equal to the minimum trigger frame processing time required by the STA 1300 if the RU adaptation is disabled for the STA 1300; and indicate the second time period to be equal to the minimum trigger frame processing time required by the STA 1300 if the RU adaptation is enabled for the STA 1300. Alternatively, in another embodiment, the TF processing time indication unit may be further configured to indicate the first time period to be equal to the minimum trigger frame processing time required by the STA 1300 if the RU adaptation is disabled for the STA 1300; or indicate the second time period to be an additional time period for calculating the minimum trigger frame processing time required by the STA 1300 if the RU adaptation is enabled for the STA 1300. In one example, the minimum trigger frame processing time may be equal to a sum of the first and the second time periods. It should be noted that in other examples, the minimum trigger frame processing time may be calculated using different ways based on the first time period and the second time period. For example, the minimum trigger frame processing time may be equal to a product of the first time period and the second time period.

Various embodiments of the invention also provide an AP for UL MU transmission in a WLAN. The AP may include a memory to store instructions for performing the first method for UL MU transmission in the WLAN, and a processor communicably coupled with the memory, the processor configured to execute the instructions to perform the first method for UL MU transmission in a WLAN as described in various embodiments of the invention.

Various embodiments of the invention also provide an STA for UL MU transmission in a WLAN. The STA may include a memory to store instructions for performing the second method for UL MU transmission in the WLAN, and a processor communicably coupled with the memory, the processor configured to execute the instructions to perform the second method for UL MU transmission in a WLAN as described in various embodiments of the invention.

Various embodiments of the invention also provide a computer program product comprising instructions to cause a computer to perform any method for UL MU transmission in a WLAN according to any embodiment of the invention, when executed thereon.

Various embodiments of the invention also provide a computer program comprising instructions to cause a computer to perform a method for UL MU transmission in a WLAN according to any embodiment of the invention, when executed thereon.

Various embodiments of the invention also provide a non-volatile storage medium comprising computer program codes to cause a computer to perform a method for UL MU transmission in a WLAN according to any embodiment of the invention, when executed thereon.

Various embodiments of the invention also provide a chip configured to perform a method for UL MU transmission in a WLAN according to any embodiment of the invention.

At least some steps of the methods for UL MU transmission in a WLAN according to any embodiments of the invention described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. Likewise, the software or firmware instructions may be delivered to a user or a system via any known or desired delivery method including, for example, on a computer readable disk or other transportable computer storage mechanism or via communication media.

As described above, with the methods and devices provided in various embodiments of the invention, a RU adaptation for an STA may be enabled by indicating the same in a Common Info field or a User Info field associated with the STA of a trigger frame. Once the STA receives the PPDU including the trigger frame and determines to perform the RU adaptation, the RU or MRU allocated to the STA may be adapted to one of a plurality of associated child RUs or MRUs so that the transmission of an EHT TB PPDU will be performed even if a part of the RU or MRU allocated to the STA is busy. Therefore, the system throughput may be increased significantly with the methods and devices provided in embodiments of the invention.

It is to be understood that the embodiments and features described above should be considered exemplary and not restrictive. Many other embodiments will be apparent to those skilled in the art from consideration of the specification and practice of the invention. The scope of the invention should, therefore, be determined with reference to the appended claims, along with the full scope of equivalents to which such claims are entitled. Furthermore, certain terminology has been used for the purposes of descriptive clarity, and not to limit the disclosed embodiments of the invention.

What is claimed is:

1. A method for uplink (UL) multi-user (MU) transmission in a wireless local area network (WLAN), the method comprising:
setting, by an AP, a Common Info field or a plurality of User Info fields of a trigger frame to indicate whether a resource unit (RU) adaptation is enabled for a plurality of STAs indicated by the plurality of User Info fields; and
transmitting, by the AP, a physical layer protocol data unit (PPDU) including the trigger frame to the plurality of STAs.

2. The method according to claim 1, wherein the setting the Common Info field or the plurality of User Info fields of the trigger frame comprises:
setting, by the AP, a first subfield of a first User Info field of the trigger frame, to indicate whether the RU adaptation is enabled for a first STA indicated by the first User Info field if RU or MRU allocated to the first STA is larger than 242 tones, wherein the RU or MRU is indicated in a second subfield and a third subfield of the first User Info field.

3. The method according to claim 2, wherein the setting the first subfield further comprises:
setting, by the AP, the first subfield of the first User Info field of the trigger frame to indicate that the RU adaptation is disabled for the first STA if the RU or MRU allocated to the first STA is used for an MU-MIMO allocation, or a carrier sensing (CS) required subfield of the Common Info field of the trigger frame is set to indicate that the plurality of STAs including the first STA are not required to use energy detection (ED) to sense medium and to consider a medium state and a network allocation vector (NAV) in determining whether or not to respond.

4. The method according to claim 1, further comprising:
receiving, by the AP, an EHT TB PPDU from a second STA of the plurality of STAs if the RU adaptation is enabled for the second STA; and
determining, by the AP, an adapted RU or MRU for the second STA based on results of signal detection, wherein the adapted RU or MRU for the second STA includes one of a plurality of child RUs or MRUs associated with the RU or MRU allocated to the second STA.

5. The method according to claim 4, further comprising: obtaining, by the AP, an adapted modulation and coding scheme (MCS) and/or a count number of spatial streams (Nss) for the second STA from a U-SIG field in the EHT TB PPDU from the second STA.

6. The method according to claim 4, wherein each of the plurality of child RUs or MRUs associated with the RU or MRU allocated to the second STA has a size of at least X % of a size of the RU or MRU allocated to the second STA, wherein X is a value in a range of 50 to 100.

7. The method according to claim 6, wherein a count number of the child RUs or MRUs associated with the RU or MRU allocated to the second STA is not greater than a predetermined value.

8. The method according to claim 7, wherein the predetermined value is 5.

9. The method according to claim 1, further comprising:
applying, by the AP, a MAC padding to the PPDU to satisfy a minimum trigger frame processing time required by any one of the plurality of STAs depending on whether the RU adaptation is enabled for the STA.

10. The method according to claim 9, further comprising:
determining, by the AP, the minimum trigger frame processing time required by the STA based on a first time period and/or a second time period indicated in an HE Capabilities element and/or an EHT Capabilities element carried in a Probe Request frame, an Association Request frame or a Reassociation Request frame transmitted from the STA to the AP.

11. The method according to claim 10, wherein the first time period is indicated in the HE Capabilities element, and the second time period is indicated in the EHT Capabilities element, or both the first time period and the second time period are indicated in the EHT Capabilities element.

12. The method according to claim 10, wherein the determining the minimum trigger frame processing time further comprises:
determining, by the AP, that the minimum trigger frame processing time required by the STA is equal to the first time period if the RU adaptation is disabled for the STA; or equal to the second time period if the RU adaptation is enabled for the STA.

13. The method according to claim 10, wherein the determining the minimum trigger frame processing time further comprises:
determining, by the AP, that the minimum trigger frame processing time required by the STA is equal to the first time period if the RU adaptation is disabled for the STA; or equal to a sum of the first and the second time periods if the RU adaptation is enabled for the STA.

14. A method for uplink (UL) multi-user (MU) transmission in a wireless local area network (WLAN), the method comprising:
receiving, by an STA, a physical layer protocol data unit (PPDU) including a trigger frame from an AP, wherein a Common Info field or a plurality of User Info fields of the trigger frame are set to indicate whether a resource unit (RU) adaptation is enabled for a plurality of STAs indicated by the plurality of User Info fields, wherein the plurality of STAs include the STA; and
decoding, by the STA, the received trigger frame to determine whether the RU adaptation is enabled for the STA.

15. The method according to claim 14, wherein if RU or MRU allocated to the STA is larger than 242 tones, a first subfield of a first User Info field of the trigger frame is set to indicate whether the RU adaptation is enabled for the STA indicated by the first User Info field, wherein the decoding the received trigger frame further comprises: decoding, by the STA, the first subfield to determine whether the RU adaptation is enabled for the STA.

16. The method according to claim 15, wherein if the RU or MRU allocated to the STA is used for an MU-MIMO allocation, or a carrier sensing (CS) required subfield of the Common Info field of the trigger frame is set to indicate that the plurality of STAs including the STA are not required to use ED to sense medium and to consider a medium state and a NAV in determining whether or not to respond, the first subfield is set to indicate that the RU adaptation is disabled for the STA, wherein the decoding the received trigger frame further comprises: decoding, by the STA, the first subfield to determine that the RU adaptation is disabled for the STA.

17. The method according to claim 14, wherein if the RU adaptation is enabled for the STA, the method further comprises:
preparing, by the STA, an EHT TB PPDU for each of a plurality of child RUs or MRUs associated with RU or MRU allocated to the STA;
adapting, by the STA, the allocated RU or MRU to one of the plurality of child RUs or MRUs according to results of energy detection (ED) based medium sensing performed by the STA; and
transmitting, by the STA, the EHT TB PPDU corresponding to the adapted child RU or MRU to the AP.

18. The method according to claim 17, further comprising: setting, by the STA, an adapted modulation and coding scheme (MCS) and/or a count number of spatial streams (Nss) in a U-SIG field of the EHT TB PPDU corresponding to the adapted child RU or MRU.

19. The method according to claim 17, wherein each of the plurality of child RUs or MRUs associated with the RU or MRU allocated to the STA has a size of at least X % of a size of the RU or MRU allocated to the STA, wherein Xis a value in a range of 50 to 100.

20. An AP for UL MU transmission in a WLAN, the AP comprising:
a processor;
a transceiver; and
a memory configured to store computer programs;
wherein the processor is configured to invoke and execute the computer programs stored in the memory to:
set a Common Info field or a plurality of User Info fields of a trigger frame to indicate whether a resource unit (RU) adaptation is enabled for a plurality of STAs indicated by the plurality of User Info fields; and
cause the transceiver to transmit a physical layer protocol data unit (PPDU) including the trigger frame to the plurality of STAs.
